(19) United States
(12) Patent Application Publication
(10) Pub. No.: US 2012/0268751 A1
(43) Pub. Date: Oct. 25, 2012

(54) IMAGE FORMING APPARATUS

(75) Inventor: Yujiro ISHIDA, Tokyo (JP)

(73) Assignee: KONICA MINOLTA BUSINESS TECHNOLOGIES, INC., Tokyo (JP)

(21) Appl. No.: 13/449,481

(22) Filed: Apr. 18, 2012

(30) Foreign Application Priority Data
Apr. 19, 2011 (JP) 2011-093246

(51) Int. Cl. G06K 15/02

(52) U.S. Cl. 358/1.1

(57) ABSTRACT

The image forming apparatus according to the present invention comprises a first guide plate 45 located along the transport direction of recording media, a second guide plate 46 that are provided facing the first guide plates along the transport direction, and air blower 47 and 48 in the transport paths 41 and 42 for transporting the recording media after fixing. The first guide plate 45 has a plurality of first vent holes 451 formed along a direction that crosses the transport direction of the recording medium. The second guide plate 46 has a plurality of the second vent holes 461 formed at staggering positions relative to the positions of the first vent holes 451. The air blower 47 and 48 blow air into the transport paths 41 and 42 or blow air out of the transport paths 41 and 42 via the first and second vent holes 451 and 461.

### CROSS-REFERENCE TO RELATED APPLICATION

This application is based on Japanese Patent. Application No. 2011-093246 filed on Apr. 19, 2011, the contents of which are incorporated herein by reference.

### BACKGROUND

1. Technical Field

The present invention relates to an image forming apparatus.

2. Description of Related Arts

In an image forming apparatus such as a copying machine and a printer, a recording medium is very hot immediately after the toner is fixed, so that it is necessary to cool it sufficiently before executing the rest of the process. In an image forming apparatus, the recording medium is typically cooled after fixation by blowing air to it with a fan (for example, see Japanese Unexamined Publication No 2010-215311).

In case of the image forming apparatus of this patent document, the recording medium that is transported between the guide plates is cooled by air that flows in or out of an air ejection port or an air suction port formed on a pair of guide plates provided opposing with each other.

However, in case of the image forming apparatus of this patent document, the recording media is not uniformly cooled as the recording medium that is transported between the guide plates as the air ejection port and the air suction port are formed in positions opposite to each other on the guide plates, causing a portion blown with air strongly and a portion blown with air weakly. Consequently, it causes a problem of generating irregular gloss on an image printed on the recording media.

The present invention is made for solving said problem associated with prior art, and an object of the present invention is to provide an image forming apparatus capable of uniformly cooling the recording media.

### SUMMARY

In order to achieve at least one of the objects described above, an image forming apparatus that reflects one mode of the present invention comprises: an image forming part that has an image generating part that forms an image on a recording medium and a fixing unit that fixes the image formed on the recording medium; and a paper transport part that transports the recording medium that has been fixed, wherein said paper transport part has a first guide plate placed along the transport path and a second guide plate to face against said first guide plate in order to form a transport path for transporting the recording media after it is fixed, wherein said first guide plate having a plurality of first vent holes formed along a specified direction crossing the transport direction of said recording medium, and said second guide plate having a plurality of second vent holes formed at staggered positions relative to the positions of said first vent holes; and an air blower blowing air into said transport path or blowing air out of said transport path via said first and second vent holes.

Said first vent holes diameters are preferably longer than the distances between the adjacent first vent holes, and said second vent holes' diameters are longer than the distances between the adjacent second vent holes.

The speed of air that flows into one side of said recording medium that is fixed immediately before is preferably slower than the speed of air that flows into the other side.

The volume of air that flows into one side of said recording medium that is fixed immediately before is preferably less than the volume of air that flows into the other side.

The temperature of air that flows into one side of said recording medium that is fixed immediately before is preferably higher than the temperature of air that flows into the other side.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a rough cross-sectional view showing the configuration of an image forming apparatus according to a first embodiment of the present embodiment.

FIG. 2A is a top view for describing the cooling mechanism of the first embodiment of the present invention.

FIG. 2B is a cross-sectional view along B-B line of FIG. 2A.

FIG. 2C is a cross-sectional view along C-C line of FIG. 2A.

FIG. 2D is a cross-sectional view along D-D line of FIG. 2A.

FIG. 3A is a top view for describing the cooling mechanism of a second embodiment of the present invention.

FIG. 3D is a cross-sectional view along B-E line of FIG. 3A.

FIG. 3C is a cross-sectional view along C-C line of FIG. 3A.

FIG. 3D is a cross-sectional view along D-D line of FIG. 3A.

FIG. 4A is a top view for describing the cooling mechanism of a third embodiment of the present invention.

FIG. 4B is a cross-sectional view along B-B line of FIG. 4A.

FIG. 4C is a cross-sectional view along C-C line of FIG. 4A.

FIG. 4D is a cross-sectional view along D-D line of FIG. 4A.

### DETAILED DESCRIPTION

The embodiments of this invention will be described below with reference to the accompanying drawings. In describing the drawings, identical elements will be identified by identical codes in order to avoid duplicating descriptions. The scaling factors of the drawings may vary from those of the actual components because of intentional exaggerations for the sake of explanations.

### First Embodiment

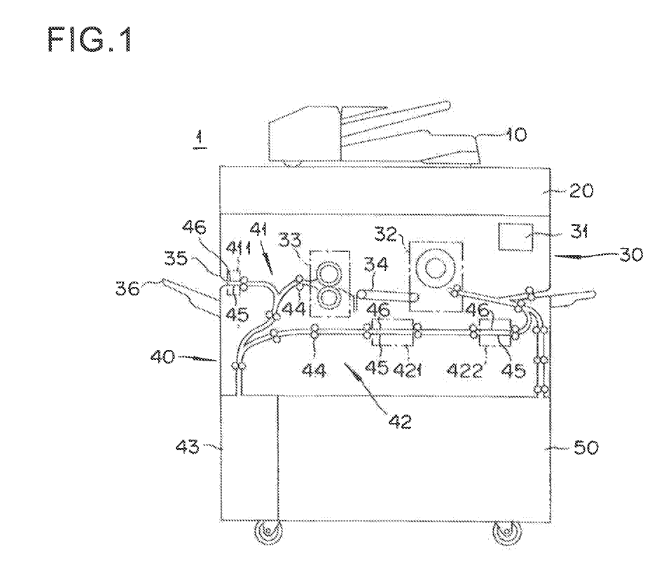

FIG. 1 is a rough cross-sectional view showing the configuration of an image forming apparatus according to a first embodiment of the present embodiment. In describing the present embodiment, a copying machine is used as the example of the image forming apparatus. As shown in FIG. 1, the image forming apparatus 1 of the present embodiment has a document feeding part 10, an image scanning part 20, an image forming part 30, a paper transport part 40, and a paper supply part 50.

The document feeding part 10 feeds the document to be copied to the image scanning part 20.

In the present embodiment, the document to be copied is placed at a specified place in advance, and the document feeding part 10 feeds the document one sheet at a time sequentially into the image scanning part 20.

The image scanning part 20 scans the image of the document and stores it. More specifically, the image scanning part 20 has a light source, an optical system, an imaging element, an image processing system, and a storage part.

The light that emanates from the light source of the image scanning part 20 irradiates the document, and its reflected light is focused on the imaging element via the optical system. The imaging element generates electric signals depending on the intensity of the light reflected from the document. The generated electric signals are treated by a compensation process, a filtration process and the like after having been converted from analog signals to digital signals in the image processing system, and are stored in the storage part as image data.

The image forming part 30 forms an image in the electronic photography process, and the formed image is fixed on a recording paper, which is used as the recording medium. More specifically, the image forming part 30 has a writing part 31, an image generating part 32, a fixing unit 33, and a transfer belt.

The writing part 31 forms an electrostatic latent image by irradiating a photoreceptor with a light emitting device such as a laser, LED or others based on the image data stored on the storage unit. The image generating part 32 electrically charges the photoreceptor, causes the toner to adhere to the electrostatic latent image formed by the writing part 31, and then transfers the image to the recording paper supplied by the paper supply part 50. The recording paper on which the image is transferred is then transported to the fixing unit 33 by the transfer belt 34. The fixing unit 33 deposits the toner that is transferred to the recording paper by means of heating and pressuring.

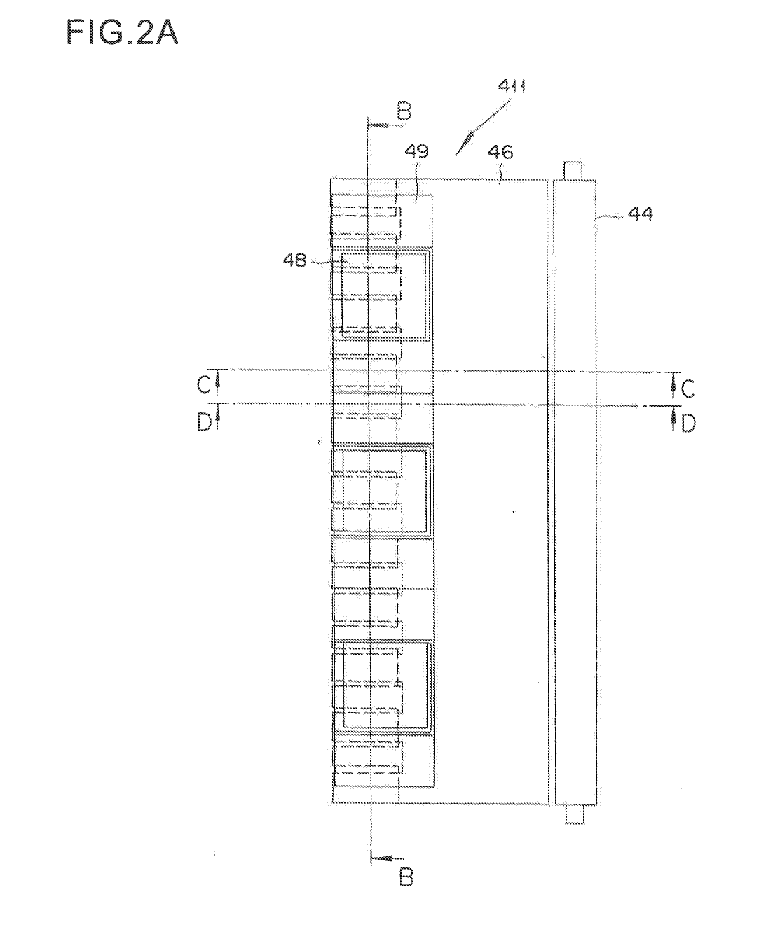

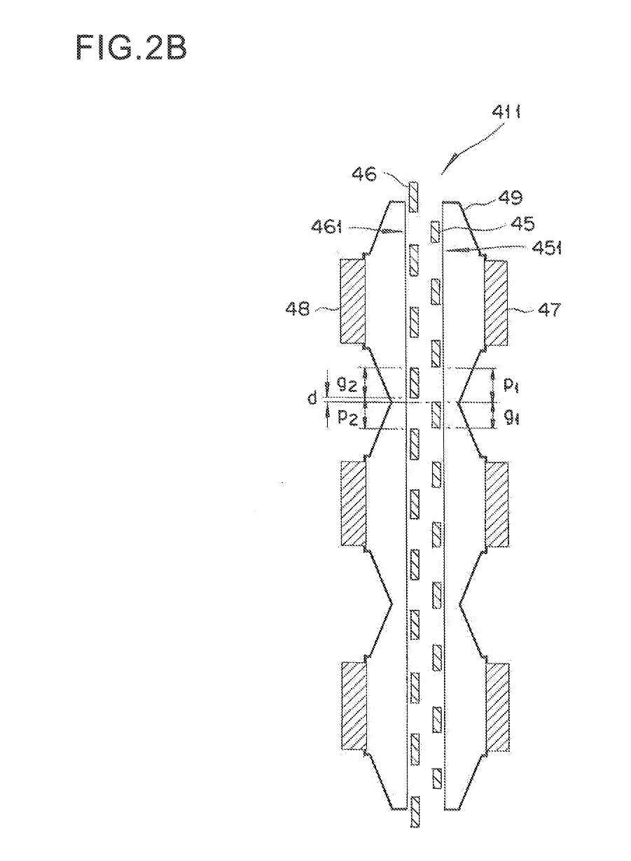

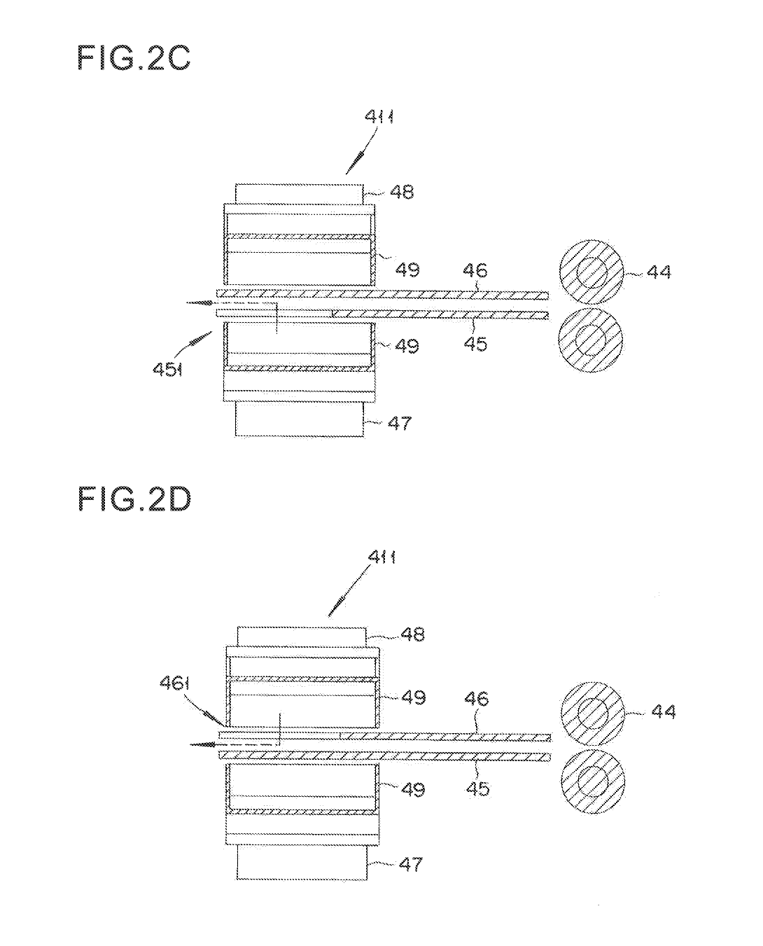

The paper transport part 40 transports the fixed recording paper while cooling it at the same time. The paper transport part 40 has a plurality of rollers 44, a plurality of first and second guide plates 45 and 46 respectively, and a plurality of fans 47 and 48 (see FIG. 2A) as air blowers.

More specifically, the paper transport part 40 has a first transport path 41 for transporting the recording paper fixed at the fixing unit 33 to a paper discharge port 35 while cooling it at the same time and discharges the paper to a paper discharge tray 36, and a second transport path 42 for transporting the recording paper fixed at the fixing unit 33 to the image generating part 32 while cooling it at the same time.

The second transport path 42 is provided with a paper turning part 43 that turns over the recording paper from front to back, so that the recording paper is supplied to the image generating part 32 with the paper turned over from front to back. Further, by executing the image generation process and the fixation process on the back side of the recording paper same as on the front side, both side printing can be achieved.

The plurality of rollers 44 transports the recording paper in the transport direction. More specifically, the plurality of rollers 44 is disposed in pairs along the first and second transport paths 41 and 42. As the rollers 44 rotate, the recording paper is transported in the transport direction as it is pinched between the rollers 44 and pushed out.

The plurality of first and second guide plates 45 and 46 guide the recording paper. More specifically, the plurality of the first guide plates 45 is disposed along the direction of the transport direction in order to guide the recording paper being transported. Furthermore, the plurality of the second guide plates 46 is disposed facing the first guide plates 45 along the direction of the transport direction in order to guide the recording paper being transported.

A more detailed description of the first and second guide plates 45 and 46, in particular, of the cooling mechanism for cooling the recording paper, is provided below with reference to FIG. 2A through FIG. 2D.

FIG. 2A is a top view for describing the cooling mechanism according to the present embodiment. FIG. 2E is a cross-sectional view along the line B-B of FIG. 2A, FIG. 2C is a cross-sectional view along the line C-C of FIG. 2A, and FIG. 2D is a cross-sectional view along the line D-D of FIG. 2A. The transport direction of the recording paper in the following description is defined as the direction moving from the right to the left of the drawing.

In the present embodiment, the first guide plate 45 is provided with a plurality of first vent holes 451 formed along a direction that crosses the transport direction of the recording paper, while the second guide plate 46 is provided with a plurality of second vent holes 461 formed at staggered positions relative to the positions of the first vent holes 451. The recording paper is cooled as the fan starts to operate to cause air to flow into the first transport path 41 via a plurality of the first and second vent holes 451 and 461.

The cooling mechanism 411 of the present embodiment is applicable, for example, to the end of the first transport path 41 as shown in FIG. 1. As the cooling mechanism 411 of the present embodiment is located at the end of the first transport path 41, no other structure exists in the downstream side of the transport direction. Since no other structure exists on the downstream side of the transport direction, there is no obstruction against the flow of air sent out by the fan so that the recording paper is effectively cooled.

As shown in FIG. 2A and FIG. 2B, the cooling mechanism 411 of the present embodiment has the first and second guide plates 45 and 46, fans 47 and 48, and a duct 49.

The first and second guide plates 45 and 46 are disposes substantially in parallel with the first transport path 41 in order to guide the recording paper along the transport direction.

Moreover, as shown in FIG. 2B, the first guide plate 45 is provided with a plurality of first vent holes 451 formed along a direction that is substantially perpendicular to the transport direction of the recording paper (hereinafter referred to as the specified direction), while the second guide plate 46 is provided with a plurality of second vent holes 461 formed at staggered positions relative to the positions of the first vent holes 451. In the present embodiment, it is preferable that the first and second vent holes 451 and 461 are formed at the ends of the first and second guide plates 45 and 46 closer to the paper discharge port 35.

The first and second vent holes 451 and 461 are formed at the ends of the first and second guide plates 45 and 46 in notched shapes as shown by dashed lines in FIG. 2A. Consequently, the ends of the first and second guide plates 45 and 46 look substantially like comb-shapes.

In the present embodiment, it is preferable that the diameters p₁ and p₂ of the first and second vent holes 451 and 461 in the specified direction are several mm to over 10 mm and longer than the distances between the adjacent vent holes g₁ and g₂ as shown in FIG. 2B. The diameters “d” of the through holes that go through both the first and second guide plates 45 and 46 generated by the first and second vent holes 451 and 461 are 1 to several mm. Thus, the recording paper receives air that goes through either one of the first and second vent holes 451 and 461.

Also, the cross-sectional shapes of the first and second vent holes 451 and 461 are not limited to any particular shape but rather can be any shapes such as rectangular, triangular, semi-circular or other shapes.

The fans 47 and 48 send out air to the first and second vent holes 451 and 461. The fans 47 and 48 are provided a specified distance apart from each other in the specified direction on the first and second guide plates 45 and 46. In the present embodiment, it is preferable that the fans 47 and 48 are provided on the first and second vent holes 451 and 461 at the ends of the first and second guide plates 45 and 46. Furthermore, although FIG. 2A and FIG. 2B show that three each of the fans 47 and 48 are provided, the number of fans in each case is not limited to three.

The volumes of air that flows into the first transport path 41 via the first and second vent holes 451 and 461 can be adjusted by controlling the volumes of air sent out by the fans 47 and 48. The temperature of the recording paper can be several 10 degrees Celsius higher on the fixing side than on the other side because the heat diffusion is prevented as a result of its own thickness.

In order to cool the fixing side uniformly, it is necessary to make the cooling capability of the air flowing onto the other side higher in proportion to the thickness of the recording paper than the cooling capability of the air flowing onto the fixing side. Consequently, it is possible to cool the fixing side of the recording paper uniformly by controlling the volume of the air flowing onto the side of the recording paper that is fixed immediately before than the volume of the air flowing onto the other side.

Moreover, assuming that the cross-sectional areas of the first and second vent holes 451 and 461 are maintained constant, the volumes of air that flow into the first transport path 41 via the first and second vent holes 451 and 461 are proportional to the speeds of air that pass through the first and second vent holes 451 and 461. Consequently, it is possible to cool the fixing side of the recording paper uniformly by controlling the speed of the air flowing onto the side of the recording paper that is fixed immediately before slower than the speed of the air flowing onto the other side.

The duct 49 guides the air sent out by the fans 47 and 46 to the first and second vent holes 451 and 461. The duct 49 is formed in such a way as to block between the adjacent fans, and the air sent out by the fans 47 and 48 to the first and second vent holes 451 and 461 without leaking outside.

The duct 49 may be equipped with an intake port for taking in the outside air as well. The outside air is cooler than the air in the inside of the image forming apparatus 1. Therefore, the cooling effect of the recording paper can be improved by cooling the recording paper by means of taking in the outside air into the first transport path 41. Moreover, utilizing the air inside the image forming apparatus 1 and the outside air, it is possible to cool the fixing side of the recording paper uniformly by raising the temperature of the air flowing onto the side of the recording paper that is fixed immediately before higher than the temperature of the air flowing onto the other side. The difference between the temperature of the air flowing into the fixing side and the temperature of the air flowing into the other side is typically several degrees Celsius.

As shown in FIG. 2C, in the area where the first vent holes 451 are formed on the first guide plate 45, the air sent out by the fan 47 flows into the first transport path 41 via the first vent hole 451. On the other hand, as shown in FIG. 2D, in the area where the second vent holes 461 are formed on the second guide plate 46, the air sent out by the fan 48 flows into the first transport path 41 via the second vent hole 461.

As can be seen from the above, according to the present embodiment, a plurality of vent holes are formed at the ends of the first and second guide plates in a staggered fashion along the specified direction that crosses the transport direction. Therefore, the air that is sent out from the fans is directed towards the recording paper via the plurality of vent holes formed in a staggered fashion along the specified direction that crosses the transport direction. Consequently, the recording paper is uniformly cooled at any arbitrary portion of it as the air is blown onto at least on one side, so that the fluctuation of gloss of the image printed on the recording media can be minimized.

### Second Embodiment

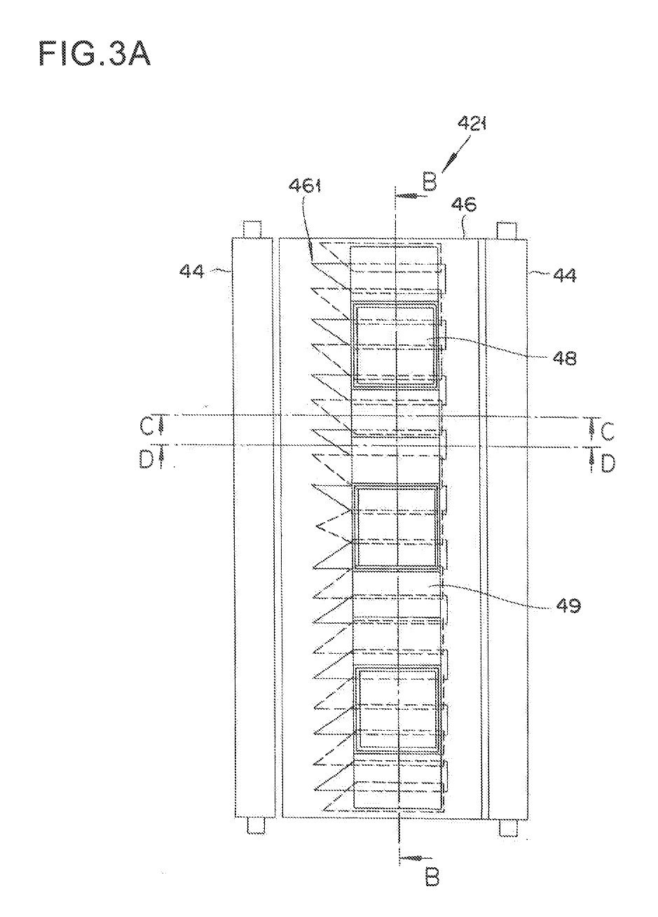

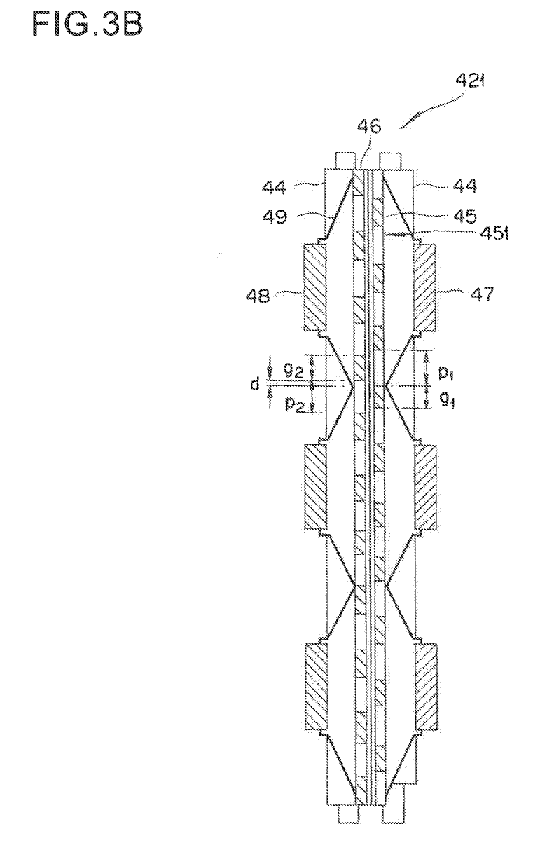

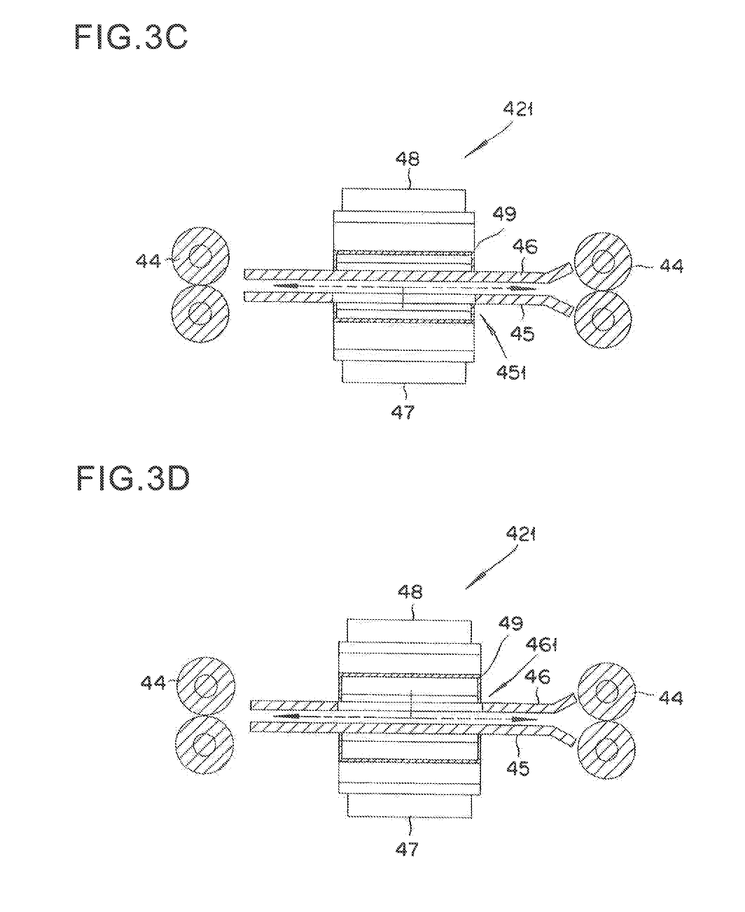

Next, the cooling mechanism of the second embodiment of the present invention is described with reference to FIG. 3A through FIG. 3D. According to the cooling mechanism of the first embodiment, a plurality of vent holes are formed at the ends of the first and second guide plates in a staggered fashion along the specified direction. According to the cooling mechanism of the second embodiment, a plurality of vent holes are formed in the middle of the first and second guide plates respectively in a staggered fashion along the specified direction. In the following description, the portions that duplicate with those of the description of the first embodiment will be omitted.

FIG. 3A is a top view for describing the cooling mechanism according to the present embodiment, FIG. 35 a cross-sectional view along the line B-B of FIG. 3A, FIG. 3C is a cross-sectional view along the line C-C of FIG. 3A, and FIG. 3D is a cross-sectional view along the line D-D of FIG. 3A.

The cooling mechanism 421 of the present embodiment is applicable, for example, to the middle part or to the part immediately behind the fixing unit 33 of the second transport path 42 as shown in FIG. 1. As shown in FIG. 3A and FIG. 35, a cooling mechanism 421 of the present embodiment has first and second guide plates 45 and 46, fans 47 and 48, and a duct 49.

The first and second guide plates 45 and 46 are disposes substantially in parallel with a second transport path 42 in order to guide the recording paper along the transport direction.

Further, as shown FIG. 3B, the first guide plate 45 is provided with a plurality of first vent holes 451 formed along the specified direction, while the second guide plate 46 is provided with a plurality of second vent holes 461 formed at staggered positions relative to the positions of the first vent holes 451. In the present embodiment, it is preferable that the first and second vent holes 451 and 461 are formed in the middle of the first and second guide plates 45 and 46 respectively.

It is preferable that the diameters p1 and p3 of the first and second vent holes 451 and 461 in the specified direction are several mm to over 10 mm and longer than the distances between the adjacent vent holes g1 and g2 as shown in FIG. 3B. Furthermore, the diameters “d” of the through holes that go through both the first and second guide plates 45 and 46 generated by the first and second vent holes 451 and 461 are 1 to several mm. The first and second vent holes 451 and 461 are formed to become narrower toward outside the recording paper square as they go toward the downstream in the downstream area of the recording paper transport direction.

The fans 47 and 48 send out air to the first and second vent holes 451 and 461. The fans 47 and 48 are provided apart from each other in the specified direction on the first and second guide plates 45 and 46. In the present embodiment, it is preferable that the fans 47 and 48 are provided on the first and second vent holes 451 and 461 of the first and second guide plates 45 and 46. Furthermore, although FIG. 3A and FIG. 3B show that three each of the fans 47 and 48 are provided, the number of fans in each case is not limited to three.

The duct 49 guides the air sent out by the fans 47 and 48 to the first and second vent holes 451 and 461. The duct 49 is formed in such a way as to block between the adjacent fans, and the air sent out by the fans 47 and 48 to the first and second vent holes 451 and 461 without leaking outside.

As shown in FIG. 3C, in the area where the first vent holes 451 are formed on the first guide plate 45, the air sent out by the fan 47 flows into the second transport path 42 via the first vent holes 451. On the other hand, as shown in FIG. 3D, in the area where the second vent holes 461 are formed on the second guide plate 46, the air sent out by the fan 48 flows into the second transport path 42 via the second vent hole 461.

As can be seen from the above, according to the present embodiment, a plurality of vent holes are formed in the middle of the first and second guide plates in a staggered fashion along the specified direction that crosses the transport direction. Therefore, the air that is sent out from the fans is directed towards the recording paper via the plurality of vent holes formed in a staggered fashion along the specified direction. Consequently, the recording paper is uniformly cooled at any arbitrary portion of it as the air is blown onto at least on one side, so that the fluctuation of gloss of the image printed on the recording media can be minimized.

Moreover, since the vent holes are provided in the middle portions of the first and second guide plates, the air path is formed uniformly on both the upstream and downstream sides of the transport direction of the recording paper starting from the middle as indicated by arrows in FIG. 3C and FIG. 3D, even if other configurations exist in the downstream side of the transport direction. Since air flows uniformly both toward upstream and downstream, the recording paper is cooled uniformly.

Moreover, the first and second vent holes are formed to become narrower toward outside the recording paper square as they go toward the downstream in the downstream area of the recording paper transport direction. Consequently, the edge of the recording paper is less likely to get stuck in the first and second vent holes when the recording paper is transported.

### Third Embodiment

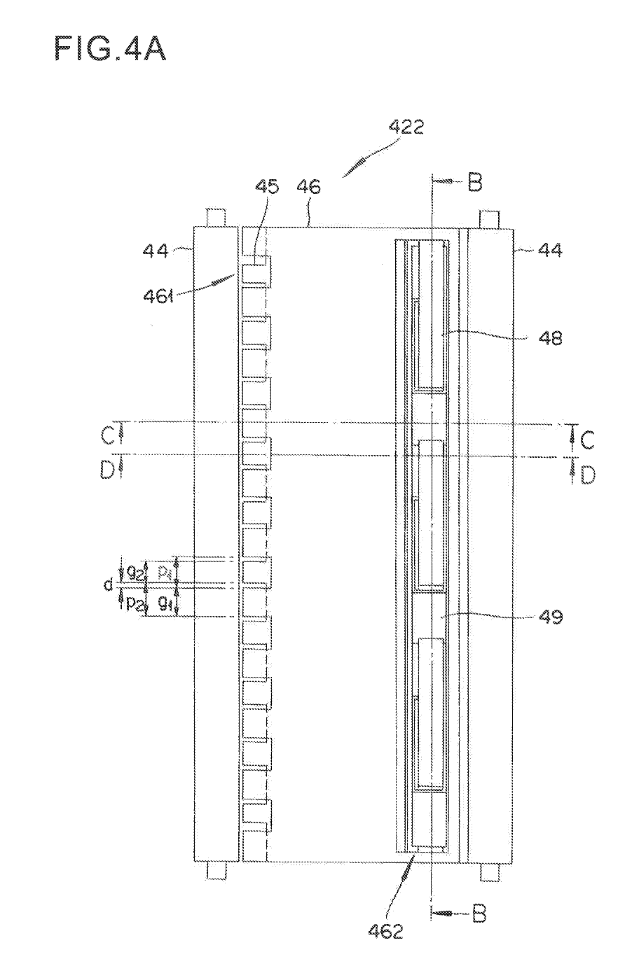

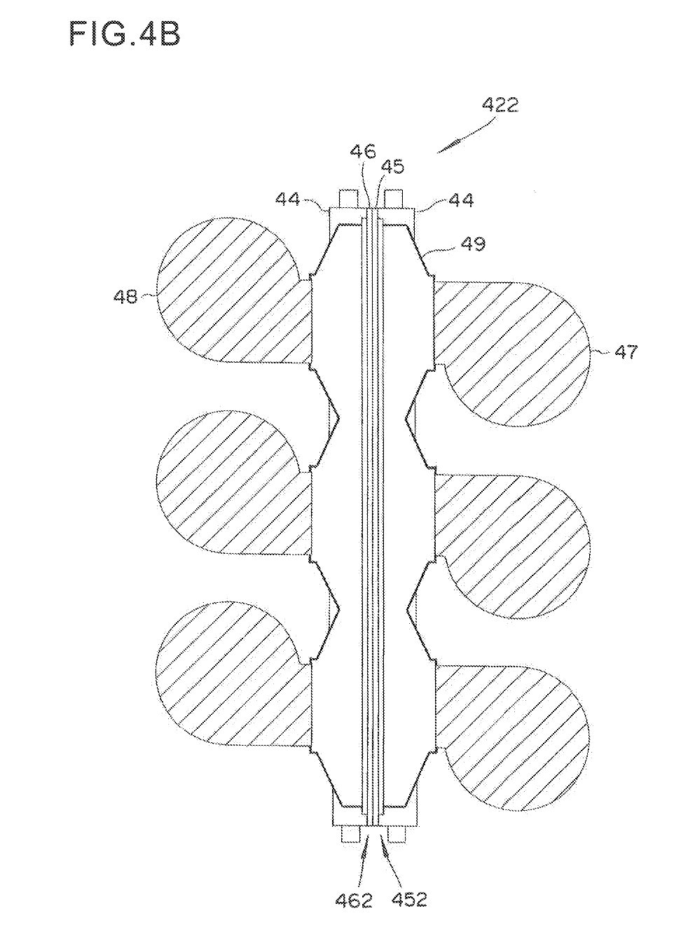

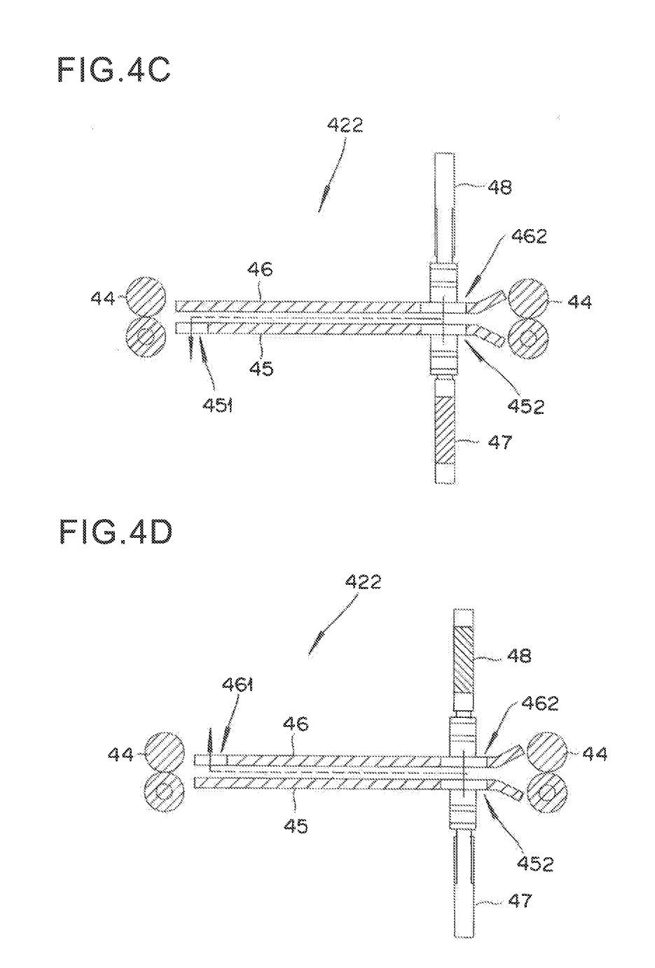

The cooling mechanism of the third embodiment of the present invention is described below with reference to FIG. 4A through FIG. 4D. In the first and second embodiment, the cooling mechanism was described as to cause the air sent out by the fans flows into the first or second transport path via a plurality of vent holes formed in the first and second guide plates. In the third embodiment, on the other hand, the cooling mechanism will be described below as to cause the air sent out by the fans flows out from the second transport path via a plurality of vent holes formed in the first and second guide plates. In the following description, the portions that duplicate with those of the description of the first and second embodiments will be omitted.

FIG. 4A is a top view for describing the cooling mechanism according to the present embodiment, FIG. 4B is a cross-sectional view along the line B-B of FIG. 4A, FIG. 4C is a cross-sectional view along the line C-C of FIG. 4A, and FIG. 4D is a cross-sectional view along the line D-D of FIG. 4A.

The cooling mechanism 422 of the present embodiment is applicable, for example, to the middle part or to the part immediately behind the fixing unit 33 of the second transport path 42 as shown in FIG. 1. As shown in FIG. 4A and FIG. 4B, a cooling mechanism 422 of the present embodiment has first and second guide plates 45 and 46, fans 47 and 48, and a duct 49.

The first and second guide plates 45 and 46 are disposes substantially in parallel with a second transport path 42 in order to guide the recording paper along the transport direction.

Further, as shown FIG. 4B, the first guide plate 45 is provided with a plurality of first vent holes 451 formed along the specified direction, while the second guide plate 46 is provided with a plurality of second vent holes 461 formed at staggered positions relative to the positions of the first vent holes 451. In the present embodiment, it is preferable that the first and second vent holes 451 and 461 are formed at the ends of the first and second guide plates 45 and 46 on the downstream side of the transfer direction.

The first and second vent holes 451 and 461 are formed at the ends of the first and second guide plates 45 and 46 in notched shapes as shown by dashed and solid lines in FIG. 4A. Therefore, the ends of the first and second guide plates 45 and 46 look substantially like comb-shapes.

It is preferable that the diameters p₁ and p₂ of the first and second vent holes 451 and 461 in the specified direction are several mm to over 10 mm and longer than the distances between the adjacent vent holes g₁ and g₂ as shown in FIG. 4A. Furthermore, the diameters “d” of the through holes that go through both the first and second guide plates 45 and 46 generated by the first and second vent holes 451 and 461 are 1 to several mm.

The first and second guide plates 45 and 46 are also provided with openings 452 and 462 in the present embodiment. It is preferable that the openings 452 and 462 are formed at the edges of the first and second guide plates 45 and 46 opposite to the edges where the first and second vent, holes 451 and 461 are formed.

The fans 47 and 48 send out air to the openings 452 and 462, in the present embodiment, the fans 47 and 48 are preferably located on the openings 452 and 462 with a specified interval apart from each other in the specified direction. Sirocco fans of high wind pressures can be used as the fans 47 and 48. The openings 452 and 462 are formed in slit-like shapes to have cross-sections matching with those of the fans 47 and 48. Furthermore, although FIG. 4A and FIG. 4B show that three each of the fans 47 and 48 are provided, the number of fans in each case is not limited to three.

The duct 49 guides the air sent out by the fans 47 and 48 to the openings 452 and 462. The duct 49 is formed in such a way as to block between the adjacent fans, and the air sent out by the fans 47 and 48 to the openings 452 and 462 without leaking outside.

As shown in FIG. 4C, in the area where the first vent holes 451 are formed on the first guide plate 45, the air sent out by the fan 47 flows out from the second transport path 42 via the first vent holes 451. On the other hand, as shown in FIG. 4D, in the area where the second vent holes 461 are formed on the second guide plate 46, the air sent out by the fan 48 flows out from the second transport path 42 via the second vent holes 461. Consequently, in the present embodiment, the air sent out by the fans 47 and 48 cools the recording paper uniformly in all areas from the area where it enters the transport path of the recording paper to the area where it is vented.

As can be seen from the above, according to the present embodiment, a plurality of vent holes are formed at the edges of the first and second guide plates in a staggered fashion along the specified direction. Therefore, the air that is sent out by the fans via the openings is vented outside from the second transport path via the plurality of vent holes formed in a staggered fashion along the specified direction. Consequently, the recording paper can be cooled uniformly.

Moreover, according to the present embodiment, the fans are provided at the end opposite to the end where the vent holes are formed. Thus, it is possible to locate the fans far apart from the vent holes even in a case that there is no room to provide the fans on the vent holes.

Such is the configurations of the image forming apparatus according to these embodiments. However, it goes without saying that the present invention can arbitrarily added, modified and omitted by a person skilled in the art within the gist of the technology disclosed herein.

For example, in the first through third embodiments, the vent holes are formed on the first and second guide plates in a direction substantially perpendicular to the transport direction of the recording paper. However, the vent holes do not necessarily have to be formed in a direction substantially perpendicular to the transport direction of the recording paper, but rather can be formed in a direction crossing the transport direction of the recording paper in an angle.

Furthermore, the first and second guide plates are provided substantially parallel to each other in the first to third embodiments. However, the first and second guide plates do not necessarily have to be provided substantially parallel to each other, but can be positioned to face each other, depending on the shape of the transport path.

What is claimed is:

1. An image forming apparatus comprising
an image forming part that has an image generating part that forms an image on a recording medium and a fixing unit that fixes the image formed on the recording medium; and
a paper transport part that transports the recording medium that has been fixed, wherein
said paper transport part has a first guide plate placed along the transport path and a second guide plate to face against said first guide plate in order to form a transport path for transporting the recording media after it is fixed,
said first guide plate having a plurality of first vent holes formed along a specified direction crossing the transport direction of said recording medium, and
said second guide plate having a plurality of second vent holes formed at staggered positions relative to the positions of said first vent holes, and
an air blower blowing air into said transport path or blowing air out of said transport path via said first and second vent holes.

2. The image forming apparatus claimed in claim 1, wherein
said first vent holes' diameters in the specified direction are longer than the distances between the adjacent first vent holes, and said second vent holes' diameters in the specified direction are longer than the distances between the adjacent second vent holes.

3. The image forming apparatus claimed in claim 1, wherein the speed of air that flows into one side of said recording medium that is fixed immediately before is slower than the speed of air that flows into the other side.

4. The image forming apparatus claimed in claim 1, wherein the volume of air that flows into one side of said recording medium that is fixed immediately before is less than the volume of air that flows into the other side.

5. The image forming apparatus claimed in claim 1, wherein the temperature of air that flows into one side of said recording medium that is fixed immediately before is higher than the temperature of air that flows into the other side.
